(19) United States
(12) Patent Application Publication
(10) Pub. No.: US 2026/0295496 A1
(43) Pub. Date: Oct. 1, 2026

(54) METHOD FOR PURIFYING BROMINE GAS

(71) Applicant: Resonac Corporation, Tokyo (JP)

(72) Inventors: Shuto OKA, Tokyo (JP); Katsuro URAKAWA, Tokyo (JP); Kazunari KAGA, Tokyo (JP)

(73) Assignee: Resonac Corporation, Tokyo (JP)

(21) Appl. No.: 19/478,916

(22) PCT Filed: Aug. 28, 2024
(86) PCT No.: PCT/JP2024/030671

§ 371 Date: Oct. 27, 2025

(30) Foreign Application Priority Data
Sep. 7, 2023 (JP) 2023-145282

(51) Int. Cl. B01D 53/02

(52) U.S. Cl. CPC B01D 53/02; B01D 2253/104; B01D 2253/108; B01D 2253/112; B01D 2253/304; B01D 2253/306; B01D 2257/2025

(57) ABSTRACT

There is provided a method for purifying a bromine gas capable of selectively removing chlorine molecules from a bromine gas. The method for purifying a bromine gas include a purification step of bringing a chlorine removing agent, having a metal bromide supported on an adsorbent, into contact with a bromine gas to remove, from the bromine gas, chlorine molecules contained in the bromine gas.

### TECHNICAL FIELD

The present disclosure relates to a method for purifying a bromine gas.

### BACKGROUND ART

A bromine gas (Br₂) produced industrially usually contains a chlorine molecule (Cl₂) as an impurity. Therefore, a method of purifying a bromine gas by removing chlorine molecules from the bromine gas has been proposed. For example, PTL 1 proposes a halogen gas removing agent that contains a sulfur-containing reducing agent such as a thiosulfate, and a pseudo boehmite.

### CITATION LIST

### Patent Literature

PTL 1: JP 6975537 B

### SUMMARY OF INVENTION

### Technical Problem

According to the technology disclosed in PTL 1, it is possible to immobilize and remove chlorine molecules in a bromine gas with a halogen gas removing agent. However, there is a concern that the bromine gas may also be immobilized and removed by the halogen gas removing agent. Therefore, a technology for selectively removing chlorine molecules in a bromine gas to purify the bromine gas has been required.

It is an object of the present disclosure to provide a method for purifying a bromine gas capable of selectively removing chlorine molecules from a bromine gas.

### Solution to Problem

To achieve the above object, one aspect of the present disclosure is as the following [1] to [6].

[1] A method for purifying a bromine gas including:
a purification step of bringing a chlorine removing agent, having a metal bromide supported on an adsorbent, into contact with a bromine gas to remove, from the bromine gas, chlorine molecules contained in the bromine gas.

[2] The method for purifying a bromine gas according to [1], in which the adsorbent includes at least one of activated alumina and zeolite.

[3] The method for purifying a bromine gas according to [1] or [2], in which the chlorine removing agent has a specific surface area of 100 m²/g or more.

[4] The method for purifying a bromine gas according to any one of [1] to [3], in which an average particle diameter of the chlorine removing agent is in a range of 0.5 mm or more and 10 mm or less.

[5] The method for purifying a bromine gas according to any one of [1] to [4], in which the metal bromide includes at least one of potassium bromide, sodium bromide, calcium bromide, and magnesium bromide.

[6] The method for purifying a bromine gas according to any one of [1] to [5], in which a content of the metal bromide in the chlorine removing agent is 1% by mass or more and 50% by mass or less.

### Advantageous Effects of Invention

According to the method for purifying a bromine gas according to the present disclosure, it is possible to selectively remove chlorine molecules from a bromine gas.

### DESCRIPTION OF EMBODIMENTS

One embodiment of the present disclosure will now be described. The embodiment is merely one example of the present disclosure, and the present disclosure is not limited to the embodiment. Various modifications or improvements can be made in the embodiment, and such modifications and improvements can be encompassed by the present disclosure.

A method for purifying a bromine gas according to the present embodiment has a purification step of bringing a chlorine removing agent, which has a metal bromide supported on an adsorbent, into contact with a bromine gas to remove, from the bromine gas, chlorine molecules contained as impurities in the bromine gas. That is, the method for purifying a bromine gas according to the present embodiment has a purification step of bringing a chlorine removing agent, which has a metal bromide supported on an adsorbent, into contact with a bromine gas to remove, from the bromine gas, chlorine molecules in the bromine gas.

With the above-described configuration, it is possible to adsorb chlorine molecules contained in the bromine gas to the chlorine removing agent while suppressing the adsorption of the bromine gas to the chlorine removing agent, and thus it is possible to selectively adsorb and remove the chlorine molecules from the bromine gas. In addition, since the method for purifying a bromine gas according to the present embodiment is a simple method, the equipment cost is small and economical.

### [Adsorbent]

The type of the adsorbent to be used in the method for purifying a bromine gas according to the present embodiment is not particularly limited as long as the adsorbent has high adsorptivity and has an average particle diameter that makes it possible to use the adsorbent as a raw material of a chlorine removing agent. Examples thereof include activated alumina and zeolite (natural zeolite and synthetic zeolite). That is, the adsorbent may have at least one of activated alumina and zeolite. As the adsorbent, at least one of activated alumina and zeolite may be used alone, or at least one of activated alumina and zeolite and another type of adsorbent may be used in combination.

### [Metal Bromide]

The type of the metal bromide to be used in the method for purifying a bromine gas according to the present embodiment is not particularly limited as long as the metal bromide functions as a component for reacting with and immobilizing a chlorine molecule. Examples thereof include an alkali metal bromide and an alkaline earth metal bromide. Examples of the alkali metal bromide include potassium bromide (KBr), sodium bromide (NaBr), calcium bromide (CaBr₂), and magnesium bromide (MgBr₂), and among these, potassium bromide or sodium bromide is preferable. That is, the metal bromide may have at least one of potassium bromide, sodium bromide, calcium bromide, and magnesium bromide.

As the metal bromide, one type of potassium bromide, sodium bromide, calcium bromide, or magnesium bromide may be used alone, or a plurality of types of these may be used in combination. In addition, as the metal bromide, only an alkali metal bromide may be used, or an alkali metal bromide and another type of metal bromide may be used in combination.

### [Chlorine Removing Agent]

The chlorine removing agent in the method for purifying a bromine gas according to the present embodiment is a chlorine removing agent in which a metal bromide is supported on an adsorbent (for example, a chlorine removing agent in which a metal bromide is supported on a surface of an adsorbent). In a case of using a chlorine removing agent obtained by supporting a metal bromide on an adsorbent, it is possible to selectively remove chlorine molecules while suppressing the adsorption of the bromine gas.

That is, in a case where an adsorbent that does not support a metal bromide is used as the chlorine removing agent, not only chlorine molecules but also bromine molecules are similarly adsorbed in the pores included in the chlorine removing agent, and thus the bromine gas is also removed. However, in a case where a chlorine removing agent that supports a metal bromide is used, the metal bromide is supported in the pores. Therefore, it is possible to selectively immobilize the chlorine molecule to the chlorine removing agent by a chemical oxidation-reduction reaction in addition to the adsorption, while physically suppressing the adsorption of the bromine molecule, as compared with the adsorbent that does not support the metal bromide. The chlorine molecules are immobilized on the surface of the chlorine removing agent, for example.

In the chlorine removing agent in the method for purifying a bromine gas according to the present embodiment, the chlorine removal rate as the outlet concentration/inlet concentration of chlorine molecules in the bromine gas that has flowed until the chlorine removing agent breaks through is high. It is presumed that this is because, in a case where an adsorbent that does not support a metal bromide is used as the chlorine removing agent, a part of the adsorbed chlorine molecules are discharged into the outlet gas by desorption, whereas in a case where the chlorine removing agent in the method for purifying a bromine gas according to the present embodiment is used, the chlorine molecules are immobilized as described above, and thus the chlorine molecules are not easily desorbed.

The content of the metal bromide in the chlorine removing agent is not particularly limited, and it may be set to 1% by mass or more and 50% by mass or less, for example. The content of the metal bromide in the chlorine removing agent is preferably 1% by mass or more and 50% by mass or less, and more preferably 5% by mass or more and 20% by mass or less. When the content of the metal bromide in the chlorine removing agent is within the above-described range, the amount of chlorine molecules capable of being removed is likely to increase, and in addition, the specific surface area of the chlorine removing agent is sufficient. Therefore, the amount of chlorine molecules removed is likely to increase in proportion to the content of the metal bromide in the chlorine removing agent.

The content of the metal bromide in the chlorine removing agent is capable of being calculated according to the following expression.

$$( W 2 - W 1 ) / W 2 \times 100 ( \% by mass )$$

W1 in the above expression is the mass of the adsorbent, and W2 is the mass of the chlorine removing agent.

An example of a method for producing a chlorine removing agent in the method for purifying a bromine gas according to the present embodiment will be described below. When an adsorbent is immersed in a solution of a metal bromide (for example, an aqueous solution of potassium bromide) and allowed to stand for a predetermined time, and then the adsorbent is taken out from the solution of the metal bromide and dried, a chlorine removing agent is capable of being obtained.

The shape of the chlorine removing agent is not particularly limited, and it may be, for example, a pellet shape, a tablet shape, or a spherical shape, and it is particularly preferably a porous shape.

The specific surface area of the chlorine removing agent is not particularly limited. From the viewpoint of suppressing the adsorption of the bromine gas and maintaining the physical strength of the particles of the chlorine removing agent, the specific surface area of the chlorine removing agent is preferably 100 m²/g or more.

The average particle diameter of the chlorine removing agent is not particularly limited, and the average particle diameter of the chlorine removing agent is preferably in a range of 0.5 mm or more and 10 mm or less, and more preferably in a range of 1 mm or more and 5 mm or less.

As the average particle diameter of the chlorine removing agent increases, the surface area involved in the adsorption diffusion of the bromine gas relatively decreases, and thus the diffusion rate of the bromine gas is slowed down as low as the surface area is reduced. However, when the average particle diameter of the chlorine removing agent is within the above-described range, the diffusion rate of the bromine gas is likely to be suitable. In addition, as the average particle diameter of the chlorine removing agent decreases, the surface area involved in the adsorption diffusion increases relatively, and thus the diffusion rate of the bromine gas itself increases. However, when the amount of the bromine gas to be treated is increased, the differential pressure between the inlet and the outlet of the removal cylinder into which the chlorine removing agent is filled and the bromine gas is introduced to purify the bromine gas is increased. However, when the average particle diameter of the chlorine removing agent is within the above-described range, the differential pressure between the inlet and the outlet of the removal cylinder for purifying the bromine gas is likely to be in a suitable range even when the amount of the bromine gas to be treated is large.

### [Method for Purifying a Bromine Gas]

An example of the method for purifying a bromine gas according to the present embodiment will be described. By a purification step of allowing a bromine gas to pass through a cylindrical removal cylinder filled with a chlorine removing agent, chlorine molecules contained in the bromine gas are adsorbed to the chlorine removing agent, whereby the bromine gas is capable of being purified.

The temperature at the time of purifying the bromine gas is not particularly limited, and it is preferably 80° C. or higher.

In addition, the concentration of chlorine molecules contained in the bromine gas is not particularly limited, and it is preferably 200 ppm by mass or less. When the concentration of chlorine molecules contained in the bromine gas is more than 200 ppm by mass, the purification may be carried out by the method for purifying a bromine gas according to the present embodiment after reducing the concentration of chlorine molecules contained in the bromine gas to 200 ppm by mass or less by a method such as distillation separation or condensation separation.

### EXAMPLES

Hereinafter, the present disclosure will be described in more detail with reference to the following examples and comparative examples.

### Example 1

A chlorine removing agent was produced using an activated alumina NST-3 (specific surface area: 156 m²/g, average particle diameter: 4.0 mm) manufactured by Nikki-Universal Co., Ltd. as an adsorbent. The specific surface area is a numerical value measured according to a BET method. The average particle diameter is a numerical value measured according to an image processing method.

100 g of an adsorbent was put into 200 mL of an aqueous solution of potassium bromide having a concentration of 15% by mass and immersed for 30 minutes to adsorb water of the aqueous solution of potassium bromide to the adsorbent. Thereafter, the adsorbent was taken out from the aqueous solution of potassium bromide and dried using a dryer at 150° C. for 3 hours to obtain a chlorine removing agent. The content (the amount of KBr supported) of the metal bromide (potassium bromide) in the obtained chlorine removing agent was 20% by mass.

The obtained chlorine removing agent was used to purify a bromine gas. A glass tube having an inner diameter of 15 mm was filled with 20 g of the chlorine removing agent to manufacture a removal cylinder. Then, a bromine gas was introduced into an inlet of one end of the removal cylinder, the bromine gas was brought into contact with the chlorine removing agent and then discharged from an outlet of the other end of the removal cylinder. The concentration (inlet concentration) of chlorine molecules contained in the bromine gas introduced into the removal cylinder is 100 ppm by mass. The speed at which the bromine gas is introduced into the removal cylinder is 100 mL/min. The temperature (that is, the temperature in the inside of the removal cylinder) at which the bromine gas is purified is 100° C., and the pressure (that is, the pressure in the inside of the removal cylinder) is 0.2 MPa. The speed of 100 mL/min for introducing the bromine gas into the removal cylinder is a numerical value at a temperature of 100° C. and a pressure of 0.2 MPa.

The masses of the chlorine removing agents before and after purification were measured. The change in the mass thereof is considered to be due to the adsorption of the bromine gas by the chlorine removing agent and is shown as the amount of bromine adsorbed in Table 1. The amount of bromine adsorbed shown in Table 1 is the amount (unit: g) of the bromine gas adsorbed per 1 kg of the chlorine removing agent. As can be seen from the results shown in Table 1, the chlorine removing agent of Example 1 suppressed the adsorption of the bromine gas.

The bromine gas discharged from the outlet of the removal cylinder was sampled, and the concentration (outlet concentration) of chlorine molecules contained in the bromine gas was measured. The method for measuring the concentration of the chlorine molecules is an ion chromatography method. Then, the chlorine removal rate was calculated for the entire amount of the bromine gas that had flowed until the chlorine removing agent broke through. The chlorine removal rate was calculated using a numerical value (outlet concentration/inlet concentration) calculated by dividing the above-described outlet concentration by the inlet concentration. The results are shown in Table 1.

The total amount of chlorine molecules (amount of chlorine removed) adsorbed to the chlorine removing agent until the concentration of chlorine molecules in the outlet gas reached 20 ppm by mass after the start of the purification was calculated. The results are shown in Table 1. The amount of chlorine removed shown in Table 1 is the amount of chlorine molecules adsorbed per 1 kg of the chlorine removing agent (where the unit is L, and the amount is a numerical value at normal temperature and normal pressure). As can be seen from the results shown in Table 1, the chlorine removing agent of Example 1 had a high ability to remove chlorine molecules.

TABLE 1

| | | | | | | Results of | |
|---|---|---|---|---|---|---|---|
| | Chlorine removing agent | | | | | purification treatment | |
| | | Amount of | Specific | Average | Amount of | Chlorine | Amount of |
| | | KBr | surface | particle | bromine | removal | chlorine |
| | | supported | area | diameter | adsorbed | rate | removed |
| | Adsorbent | (% by mass) | (m²/g) | (mm) | (g/kg) | (%) | (L/kg) |
| Ex. 1 | Activated | 20 | 130 | 4.1 | 9.9 | 96.1 | 31 |
| | alumina | | | | | | |
| Ex. 2 | Zeolite | 20 | 270 | 2.5 | 20.0 | 93.3 | 29 |
| Ex. 3 | Activated | 0.1 | 144 | 4.0 | 43.7 | 94.8 | 19 |
| | alumina | | | | | | |
| Comp. Ex. 1 | Activated | 0 | 156 | 4.0 | 94.7 | 80.7 | 10 |
| | alumina | | | | | | |
| Comp. Ex. 2 | Zeolite | 0 | 409 | 2.3 | 134.2 | 87.7 | 14 |

### Example 2

A chlorine removing agent was produced using zeolite CLR-454 (specific surface area: 409 m²/g, average particle diameter: 2.3 mm) manufactured by Resonac Universal Corporation as an adsorbent.

20 g of an adsorbent was put into 200 mL of an aqueous solution of potassium bromide having a concentration of 35% by mass and immersed for 30 minutes to adsorb water from the aqueous solution of potassium bromide to the adsorbent. Thereafter, the adsorbent was taken out from the aqueous solution of potassium bromide and dried using a dryer at 150° C. for 3 hours to obtain a chlorine removing agent. The content of the metal bromide (potassium bromide) in the obtained chlorine removing agent was 20% by mass.

The purification of the bromine gas was carried out in the same manner as in Example 1 except for the above-described points, and then the amount of bromine adsorbed, the chlorine removal rate, and the amount of chlorine removed were calculated. The results are shown in Table 1.

As can be seen from the results shown in Table 1, the chlorine removing agent of Example 2 had a small amount of bromine gas adsorbed and a high ability to remove chlorine molecules.

### Example 3

The purification of the bromine gas was carried out in the same manner as in Example 1 except that the content of potassium bromide was 0.1% by mass, and then the amount of bromine adsorbed, the chlorine removal rate, and the amount of chlorine removed were calculated. The results are shown in Table 1.

As can be seen from the results shown in Table 1, since the chlorine removing agent of Example 3 had a small amount of potassium bromide supported, the amount of bromine adsorbed was large, and the amount of chlorine removed was small as compared with Example 1.

### Comparative Example 1

The purification of the bromine gas was carried out in the same manner as in Example 1 except that the activated alumina that was not allowed to support potassium bromide was used as it was as a chlorine removing agent, and then the amount of bromine adsorbed, the chlorine removal rate, and the amount of chlorine removed were calculated. The results are shown in Table 1.

As can be seen from the results shown in Table 1, since the chlorine removing agent of Comparative Example 1 did not support potassium bromide, the amount of bromine gas adsorbed was large, and the chlorine removal rate was low. In addition, since the concentration of chlorine molecules in the outlet gas early reached 20 ppm by mass as compared with that in Example 1, the amount of chlorine removed was small.

### Comparative Example 2

The purification of the bromine gas was carried out in the same manner as in Example 2 except that the zeolite that was not allowed to support potassium bromide was used as it was as a chlorine removing agent, and then the amount of bromine adsorbed, the chlorine removal rate, and the amount of chlorine removed were calculated. The results are shown in Table 1.

As can be seen from the results shown in Table 1, since the chlorine removing agent of Comparative Example 2 did not support potassium bromide, the chlorine removal rate was low. In addition, since the concentration of chlorine molecules in the outlet gas early reached 20 ppm by mass as compared with that in Example 2, the amount of chlorine removed was small.

1. A method for purifying a bromine gas comprising:
a purification step of bringing a chlorine removing agent, having a metal bromide supported on an adsorbent, into contact with a bromine gas to remove, from the bromine gas, chlorine molecules contained in the bromine gas.

2. The method for purifying a bromine gas according to claim 1, wherein the adsorbent comprises at least one of activated alumina and zeolite.

3. The method for purifying a bromine gas according to claim 1, wherein the chlorine removing agent has a specific surface area of 100 m²/g or more.

4. The method for purifying a bromine gas according to claim 1, wherein an average particle diameter of the chlorine removing agent is in a range of 0.5 mm or more and 10 mm or less.

5. The method for purifying a bromine gas according to claim 1, wherein the metal bromide comprises at least one of potassium bromide, sodium bromide, calcium bromide, and magnesium bromide.

6. The method for purifying a bromine gas according to claim 1, wherein a content of the metal bromide in the chlorine removing agent is 1% by mass or more and 50% by mass or less.

7. The method for purifying a bromine gas according to claim 2, wherein the chlorine removing agent has a specific surface area of 100 m²/g or more.

8. The method for purifying a bromine gas according to claim 2, wherein an average particle diameter of the chlorine removing agent is in a range of 0.5 mm or more and 10 mm or less.

9. The method for purifying a bromine gas according to claim 2, wherein the metal bromide comprises at least one of potassium bromide, sodium bromide, calcium bromide, and magnesium bromide.

10. The method for purifying a bromine gas according to claim 2, wherein a content of the metal bromide in the chlorine removing agent is 1% by mass or more and 50% by mass or less.
